(19) United States
(12) Patent Application Publication
(10) Pub. No.: US 2011/0156645 A1
(43) Pub. Date: Jun. 30, 2011

(54) ALL-IN-ONE LITHIUM BATTERY CHARGER

(75) Inventor: FU-I YANG, TAOYUAN COUNTY (TW)

(73) Assignee: SAMYA TECHNOLOGY CO., LTD., TAOYUAN COUNTY (TW)

(21) Appl. No.: 12/648,630

(22) Filed: Dec. 29, 2009

(51) Int. Cl. H02J 7/00

(52) U.S. Cl. 320/110; 320/107

(57) ABSTRACT

An all-in-one lithium battery charger, and more particularly, to a charging seat specifically designed for the Kodak KLIC series lithium batteries. The charging seat includes a first charging terminal set in the lateral direction and a second charging terminal set in the longitudinal direction such that they are arranged in an L-shaped manner. Moreover, the bottom plate of the charging seat includes different bottom portions positioned at different height for defining different sized charging grooves. In this way, at least six types of lithium batteries can be charged therein without increasing the volume of the chargers, thereby achieving the all-in-one charging purpose. Moreover, the convenient storage and carrying is ensured.

### BACKGROUND OF THE INVENTION

1. Field of the Invention

The invention relates to an all-in-one lithium battery charger, and more particularly to a charger that is suitable for charging six types of Kodak KLIC series lithium batteries.

2. Description of the Related Art

The 3C-products (computer/communication/consumer electronics) continue to introduce new designs, styles, and functions. Accordingly, the lithium batteries needed for the operation thereof were brought into the market unceasingly. The lithium batteries for Kodak 3C products alone have different models such as KLIC-7000, KLIC-7001, KLIC-7003, KLIC-7004, KLIC-7005 and KLIC-7006.

Previously, different chargers have to be designed for different models of the conventional nickel batteries. As a result, the user needs to prepare for corresponding chargers. This causes inconvenience in use. Moreover, much trouble tends to arise when so many different chargers are stored and carried, thereby increasing invisible cost.

Therefore, a Kodak type all-in-one charger 10, shown in FIGS. 1A and 1B, was developed for avoiding the above-mentioned disadvantages. The charger 10 includes a base 11 with a recess 111 at the top thereof for mechanically and electrically connecting an adjustable charging seat 12. A slide cover 121 is positioned at the top of the adjustable charging seat 12. A charging groove 122 for accommodating a certain battery B is created by adjusting the position of the slide cover 121. In this way, a single charger is suitable for different lithium batteries having different models and dimensions.

The above-mentioned all-in-one charger 10 has the function to adjust the size of the charging groove. However, it is impractical to carry it due to its large volume. Moreover, the use is not convenient since the position of the slide cover 121 has to be adjusted when different batteries are charged.

### SUMMARY OF THE INVENTION

An object of the invention is to eliminate the above-mentioned drawbacks of the conventional all-in-one charger and to provide a multipurpose charger, based on the conventional charger's structure, for charging at least six types of Kodak KLIC series lithium batteries without increasing the volume thereof, thereby achieving the six-in-one charging effect.

In order to achieve the above-mentioned objects, the invention includes:

a) a bottom casing having a through hole at the tail thereof;

b) a circuit board positioned within the bottom casing with a USB port facing to the through hole such that an electric connection to an external power source may be established via the USB port and the external power source may serve as the charging power source, the circuit board being provided with a first charging terminal set in the lateral direction and a second charging terminal set in the longitudinal direction such that the first and second charging terminal sets are arranged in an L-shaped manner;

c) a charging seat having a bottom plate, a lateral upright plate at the tail of the bottom plate, and an upright side plate adjacent to the lateral upright plate, the lateral upright plate and the upright side plate having a plurality of slots facing to the first and second charging terminal sets such that the first and second charging terminal sets may jut out of the slots, respectively; and

d) a top casing having an opening corresponding to the charging seat such that the charging seat may fit into the opening, the front side of the top casing having a first bottom portion and a second bottom portion positioned closely to the bottom plate of the charging seat, the second bottom portion being disposed higher than the first bottom portion, the top casing sitting on the bottom casing to permit a practical insertion of different kinds of lithium batteries into a charging groove (positioned at the top of the top casing) for conducting a charging process.

According to the invention, at least four charging grooves are created by different bottom portions formed at different heights such that six types of Kodak KLIC series lithium batteries may be placed and charged within the corresponding charging grooves.

### BRIEF DESCRIPTION OF THE DRAWINGS

The accomplishment of this and other objects of the invention will become apparent from the following descriptions and its accompanying figures of which:

FIG. 1A is an exploded perspective view of a conventional lithium battery charger;

FIG. 1B is a perspective view showing the use of the conventional lithium battery charger;

FIG. 2 is an exploded perspective view of the charger in accordance with the invention;

FIG. 3 is a perspective view of the invention with a swivel cover in an opened position;

FIG. 4 is a perspective view of the invention with the swivel cover in a closed position;

FIG. 5 is a top view of the charger in accordance with the invention;

FIG. 6 is a cutaway view taken along the line 6-6 in FIG. 5;

FIG. 7A is a perspective view of the invention for charging KLIC-7000 lithium battery;

FIG. 7B is a top view of the invention for charging KLIC-7000 lithium battery;

FIG. 8A is a perspective view of the invention for charging KLIC-7001 lithium battery;

FIG. 8B is a top view of the invention for charging KLIC-7001 lithium battery;

FIG. 9A is a perspective view of the invention for charging KLIC-7004 lithium battery;

FIG. 9B is a top view of the invention for charging KLIC-7004 lithium battery;

FIG. 10A is a perspective view of the invention for charging KLIC-7005 lithium battery;

FIG. 10B is a top view of the invention for charging KLIC-7005 lithium battery;

FIG. 11A is a perspective view of the invention for charging KLIC-7003 lithium battery;

FIG. 11B is a top view of the invention for charging KLIC-7003 lithium battery;

FIG. 12A is a perspective view of the invention for charging KLIC-7006 lithium battery; and

FIG. 12B is a top view of the invention for charging KLIC-7006 lithium battery.

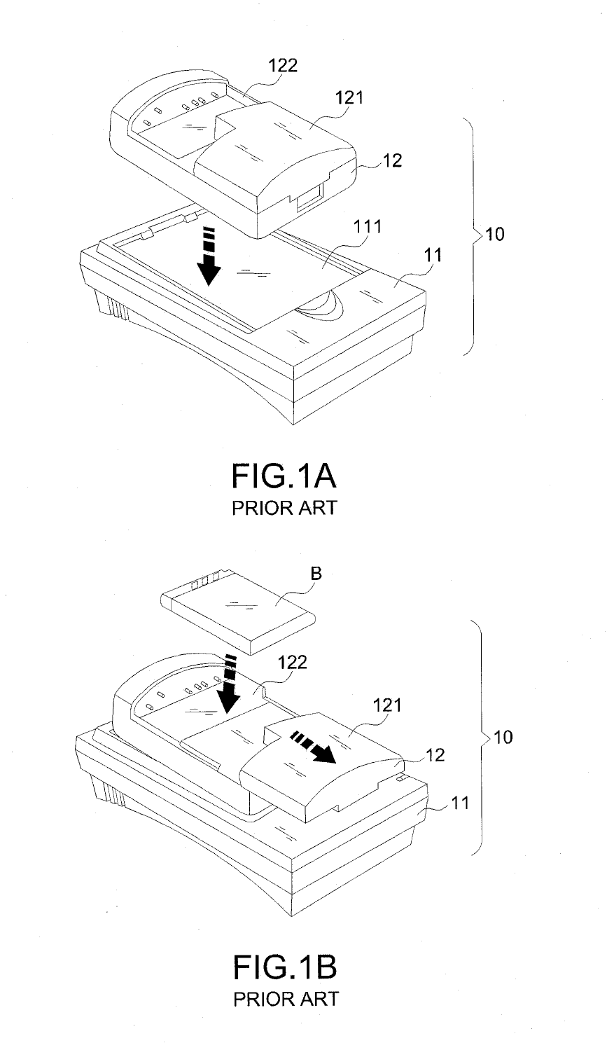

### DETAILED DESCRIPTION OF THE PREFERRED EMBODIMENT

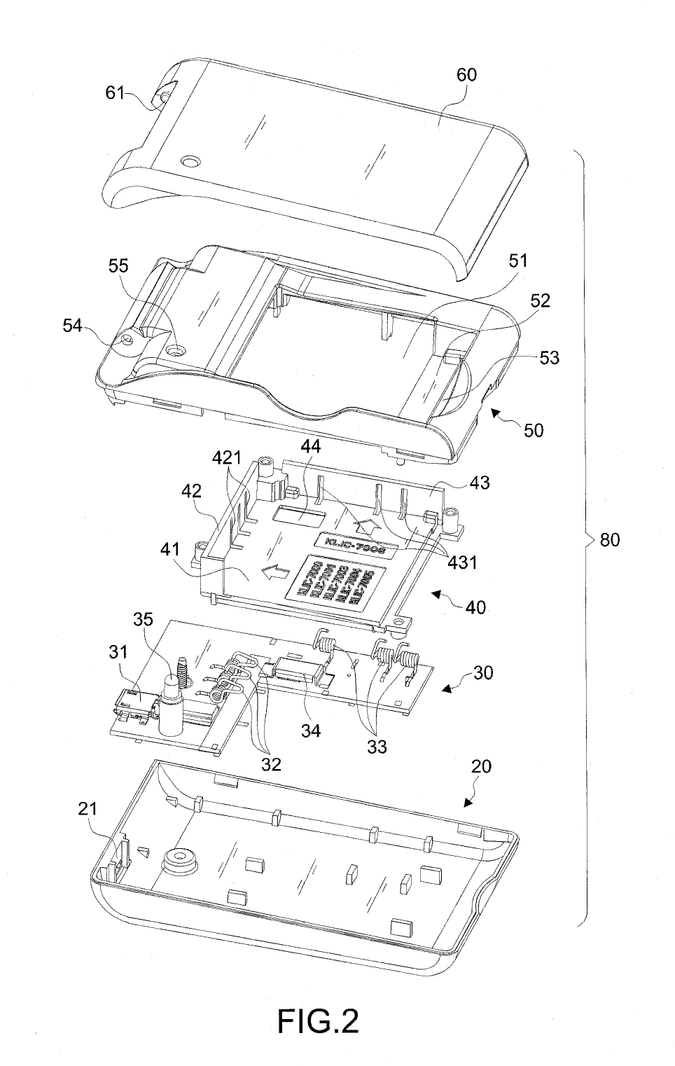

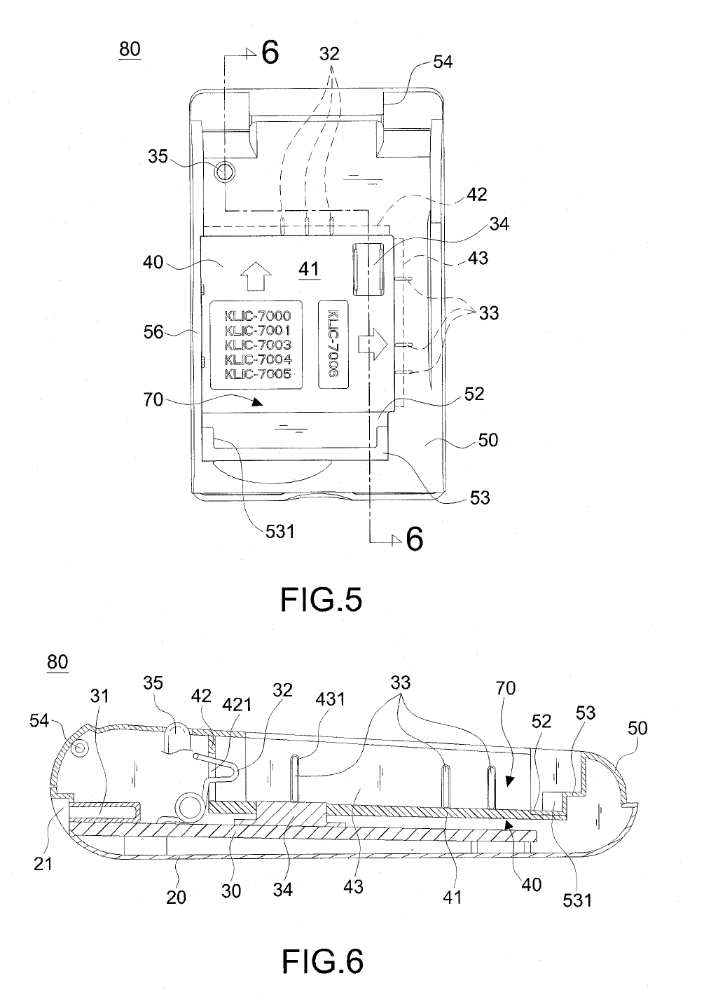

First of all, referring to FIGS. 2 through 6, an all-in-one charger 80 in accordance with a preferred embodiment of the invention includes a bottom casing 20, a circuit board 30, a charging seat 40, and a top casing 50.

The bottom casing 20 includes a through hole 21 at the tail thereof. The position of the through hole 21 is not limited to thereto. That is, it may be formed at the side of the bottom casing 20, too.

The circuit board 30 is positioned within the bottom casing 20 with a USB port 31 facing to the through hole 21. In this way, an electric connection to an external power source may be established via the USB port 31 such that the external power source may serve as the charging power source. The circuit board 30 is provided with a first charging terminal set 32 in the lateral direction and a second charging terminal set 33 in the longitudinal direction such that the first and second charging terminal sets 32, 33 are arranged in an L-shaped manner.

The charging seat 40 includes a bottom plate 41, a lateral upright plate 42 at the tail of the bottom plate 41, and an upright side plate 43 adjacent to the lateral upright plate 42. The lateral upright plate 42 and the upright side plate 43 include a plurality of slots 421, 431 facing to the first and second charging terminal sets 32, 33 such that the first and second charging terminal sets 32, 33 may jut out of the slots 421, 431, respectively.

The top casing 50 includes an opening 51 corresponding to the charging seat 40 such that the charging seat 40 may fit into the opening 51. The front side of the top casing 50 includes a first bottom portion 52 and a second bottom portion 53 positioned closely to the bottom plate 41 of the charging seat 40. The second bottom portion 53 is disposed higher than the first bottom portion 52. The top casing 50 sits on the bottom casing 20. In this way, different kinds of lithium batteries may be placed into a charging groove 70 (positioned at the top of the top casing 50) for conducting a charging process.

Moreover, a light-emitting diode 35 is disposed on the circuit board 30 while the top casing 50 includes a round hole 55 from which the top the light-emitting diode 35 projects. In addition, the top casing 50 includes a pivot seat 54 at the rear side thereof for pivotally connecting a swivel cover 60. According to the embodiment, the swivel cover 60 includes pivot pins 61 fitting into the corresponding pivot holes in the pivot seat 54 such that the swivel cover 60 may be moved upwards in an opened position or moved downward to the surface of the top casing 50 in a closed position. The swivel cover 60 is mounted when required, and it is not a necessary component for the structure of the invention.

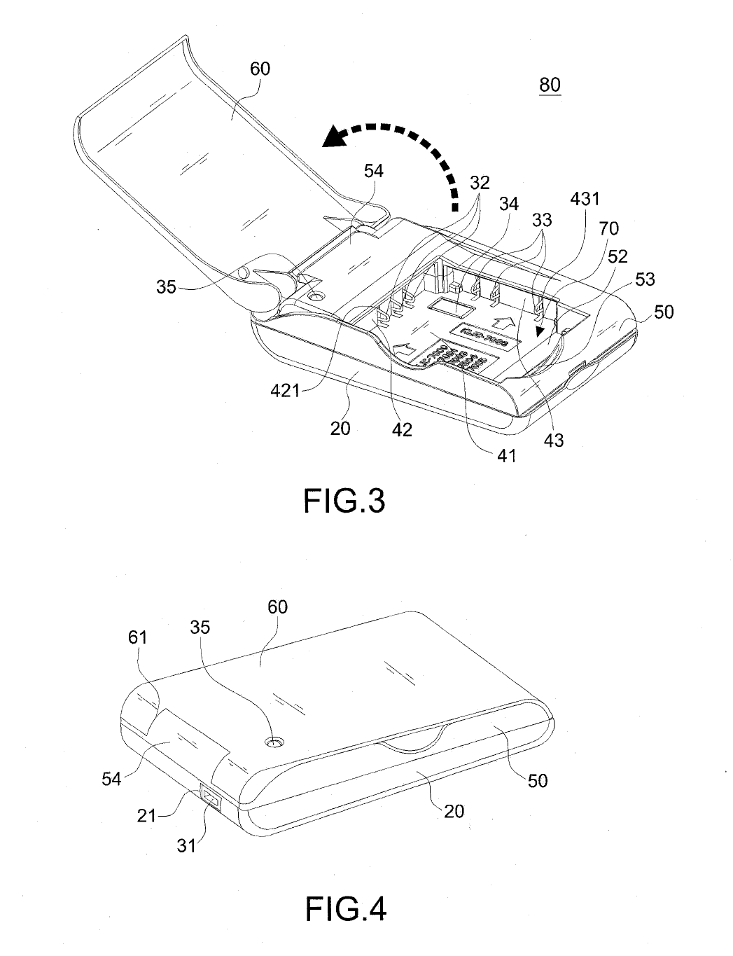

Another feature of the invention lies in that the circuit board 30 includes a temperature sensor 34 (see FIGS. 2 and 3). The bottom plate 41 of the charging seat 40 is provided with a recess 44 corresponding to the temperature sensor 34 such that the temperature sensor 34 is exposed on the surface of the bottom plate 41 of the charging seat 40. In this way, temperature detection on the lithium battery charged within the charging groove 70 can be performed. In addition to the control over the charging temperature of the circuit board 30, the temperature sensor 34 is positioned on the surface of the bottom plate 41 such that the bottom of the lithium battery in the charging process tends to be in contact with the temperature sensor 34. Therefore, the charging power from the circuit board 30 will be disconnected when an extraordinary temperature is detected. In this way, a double protection of the battery in the charging process is ensured.

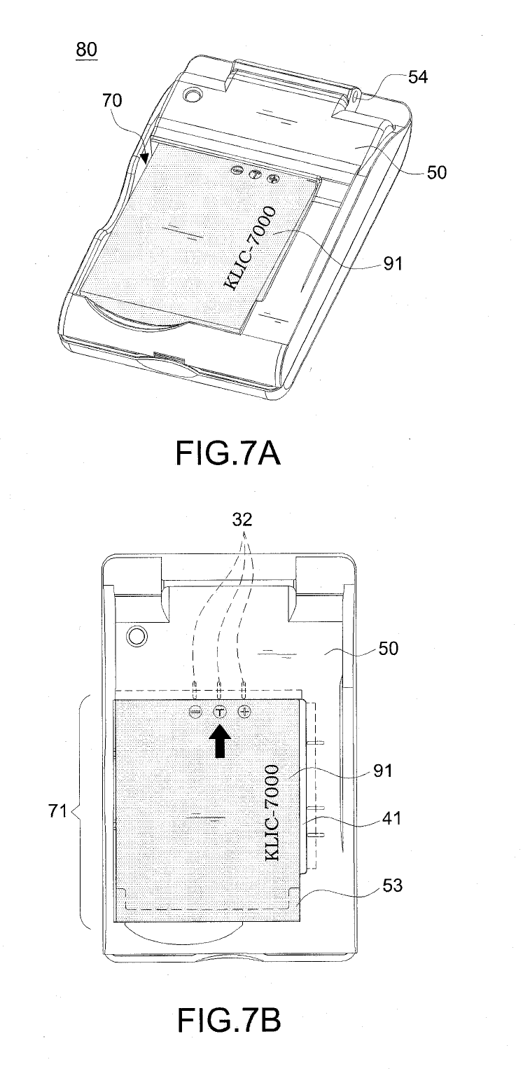

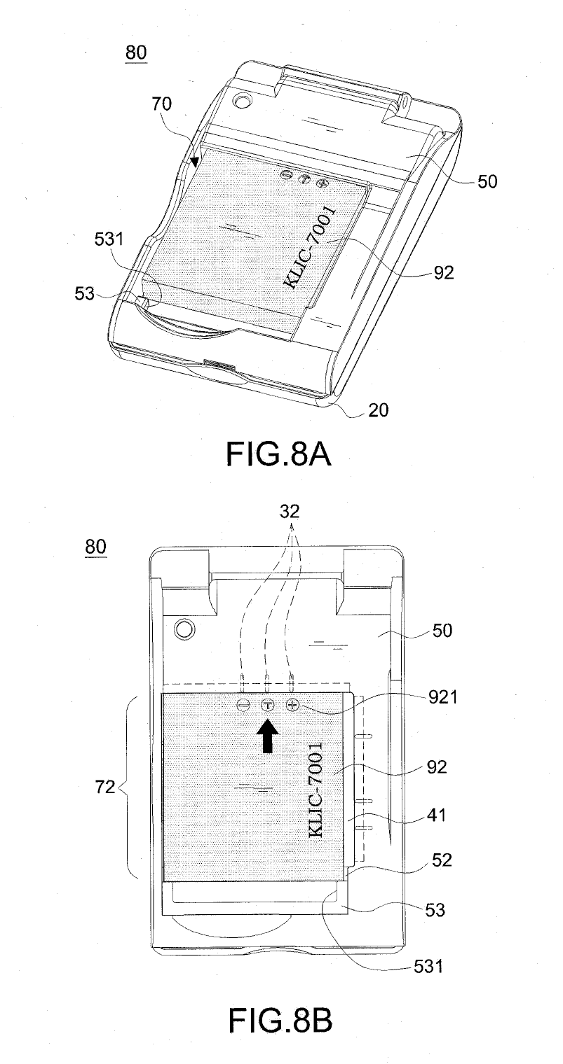

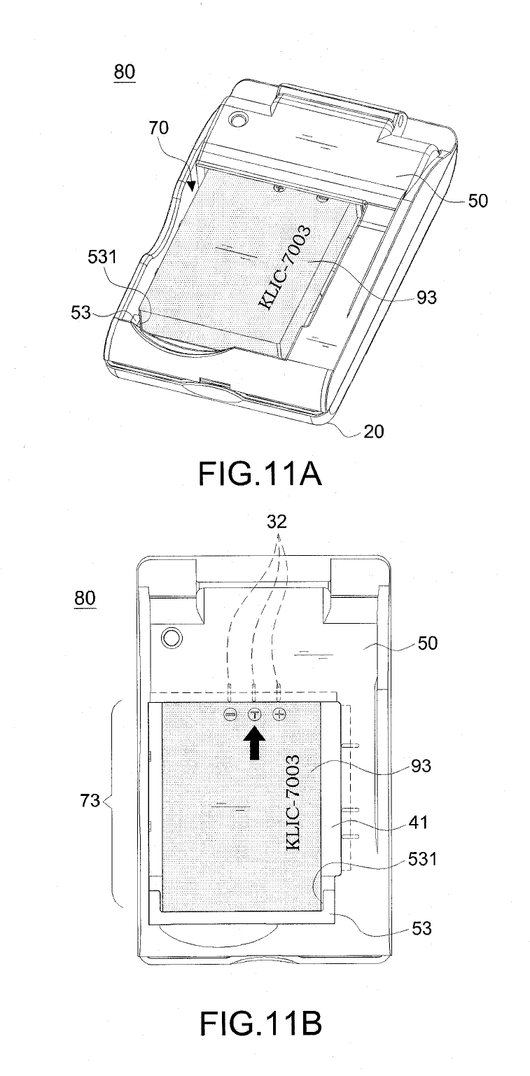

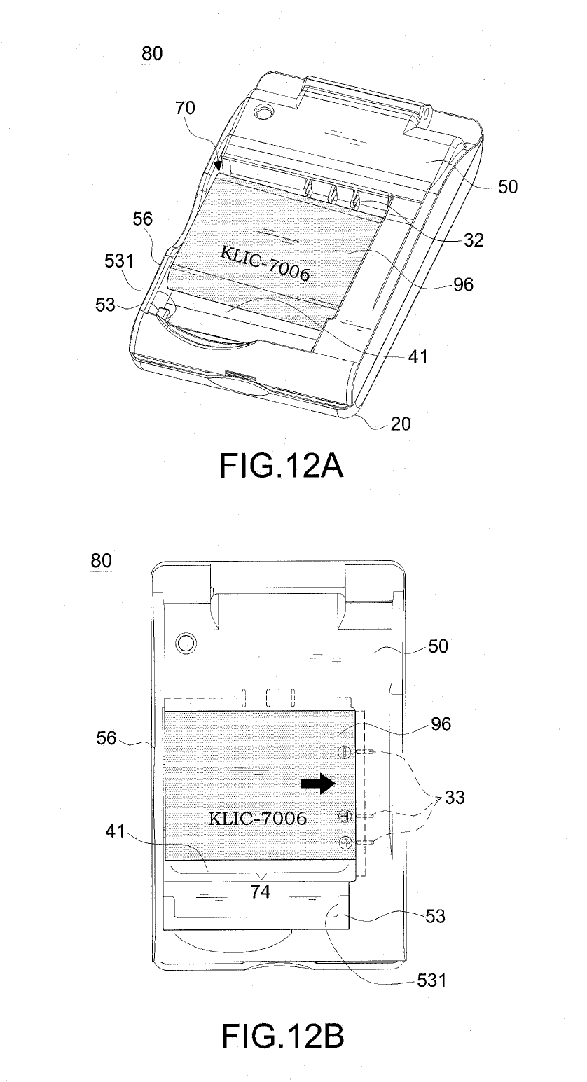

In order to build up an all-in-one charging groove, the first bottom portion 52 of the top casing 50 is flushed with the bottom plate 41 of the charging seat 40. Meanwhile, the higher U-shaped member 531 of the second bottom portion 53 is adjacent to the front side wall of the top casing 50. In this way, a first charging groove 71 is formed in the area between the first charging terminal set 32 and the surface of the second bottom portion 53 (see FIG. 7B). A second charging groove 72 is formed in the area between the first charging terminal set 32 and the surface of the first bottom portion 52 (see FIG. 8B). A third charging groove 73 is formed in the area between the first charging terminal set 32 and the inner side of the U-shaped member 531 of the second bottom portion 53 (see FIG. 11B). In addition, a fourth charging groove 74 is formed in the area of the bottom plate 41 and between the second charging terminal set 33 and the side wall 56 of the top casing 50 (see FIG. 12B).

As shown in FIGS. 7A and 7B, the first charging groove 71 is adapted to receive a Kodak KLIC-7000 lithium battery 91 for performing the charging process.

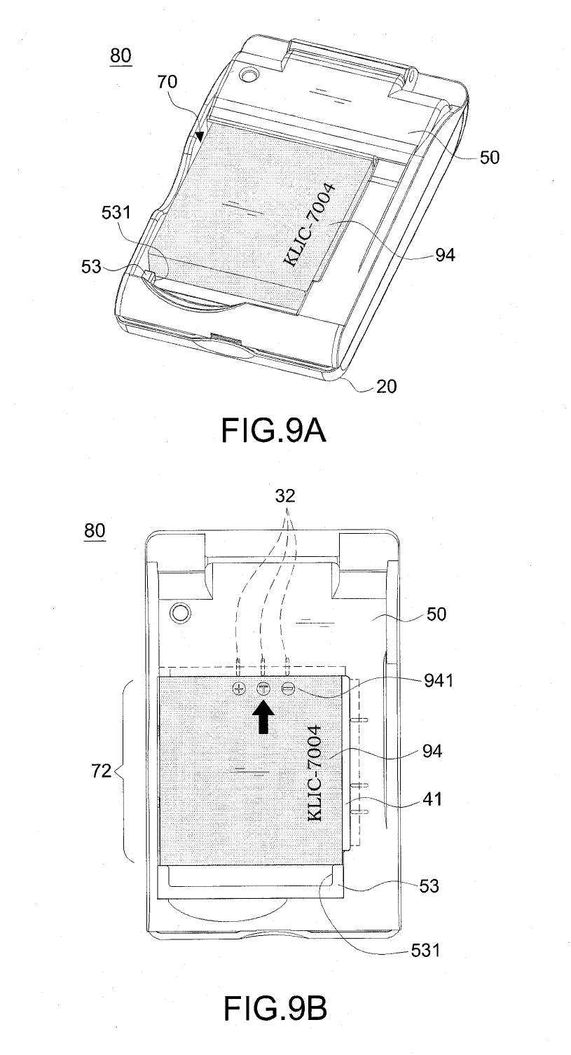

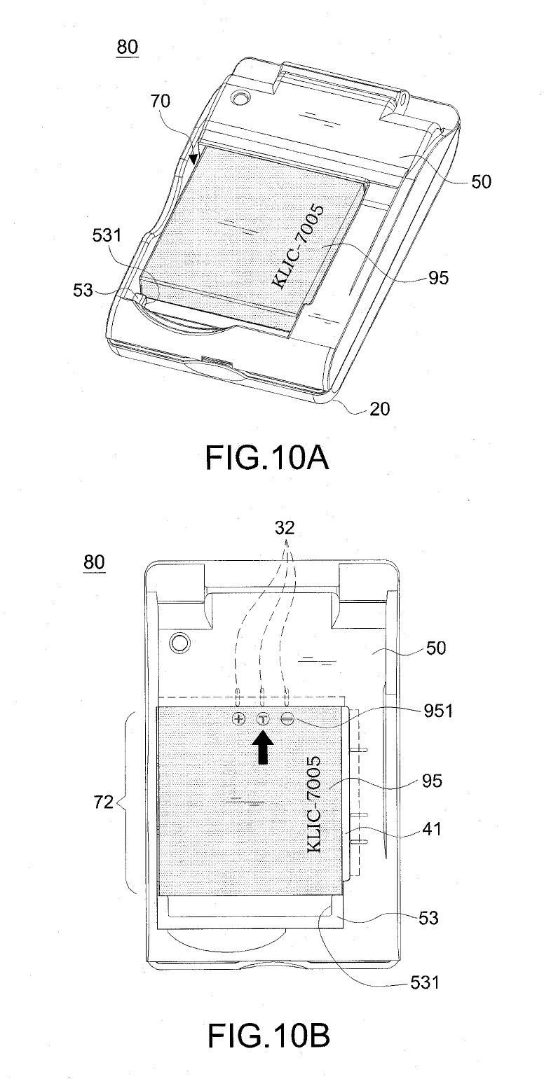

As shown in FIGS. 8A and 8B, the second charging groove 72 is adapted to receive a Kodak KLIC-7001 lithium battery 92 for performing the charging process. As shown in FIGS. 9A, 9B, 10A, and 10B, the Kodak KLIC-7004 lithium battery 94 and the Kodak KLIC-7005 lithium battery 95 are similar in contour to the Kodak KLIC-7001 lithium battery 92. As a result, they may be charged in the second charging groove 72 as well. However, the charging contacts 941, 951 of the Kodak KLIC-7004 lithium battery 94 and the Kodak KLIC-7005 lithium battery 95 are opposite in polarity to the charging contacts 921 of the Kodak KLIC-7001 lithium battery 92. Thus, the circuit board 30 has to be provided with a circuit for detecting the positive and negative terminals to permit an automatic adjustment of the charging loop. This technique is filed for another patent application so that no further descriptions thereto are given hereinafter. Accordingly, the second charging groove 72 can be applied to charge the above-mentioned three different types of lithium batteries.

As shown in FIGS. 11A and 11B, the third charging groove 73 is adapted to receive a Kodak KLIC-7003 lithium battery 93 for performing the charging process. Both inner sides of the U-shaped member 531 are specially provided for a smooth insertion of the lithium battery 93.

As shown in FIGS. 12A and 12B, the fourth charging groove 74 is adapted to receive a Kodak KLIC-7006 lithium battery 96 in a lateral direction for performing the charging process.

It is apparent from the above-mentioned that the charging groove 70 does its best to fulfill the all-in-one purpose such that different charging grooves 71-76 are created within a small space for charging six types of lithium batteries. Thus, a full utilization of space is achieved. Besides, the structure of the invention is sufficiently small and light-weight to allow convenient carry and use. Moreover, the cost can be minimized.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

What is claimed is:

1. An all-in-one lithium battery charger, comprising:
a) a bottom casing having a through hole at the tail thereof;
b) a circuit board positioned within the bottom casing with a USB port facing to the through hole such that an electric connection to an external power source may be established via the USB port and the external power source may serve as the charging power source, the circuit board being provided with a first charging terminal set in the lateral direction and a second charging terminal set in the longitudinal direction such that the first and second charging terminal sets are arranged in an L-shaped manner;
c) a charging seat having a bottom plate, a lateral upright plate at the tail of the bottom plate, and an upright side plate adjacent to the lateral upright plate, the lateral upright plate and the upright side plate having a plurality of slots facing to the first and second charging terminal sets such that the first and second charging terminal sets may jut out of the slots, respectively; and
d) a top casing having an opening corresponding to the charging seat such that the charging seat may fit into the opening, the front side of the top casing having a first bottom portion and a second bottom portion positioned closely to the bottom plate of the charging seat, the second bottom portion being disposed higher than the first bottom portion, the top casing sitting on the bottom casing to permit a practical insertion of different kinds of lithium batteries into a charging groove (positioned at the top of the top casing) for conducting a charging process.

2. The all-in-one lithium battery charger as recited in claim 1 wherein the circuit board includes a temperature sensor, and the bottom plate of the charging seat is provided with a recess corresponding to the temperature sensor such that the temperature sensor is exposed on the surface of the bottom plate of the charging seat, whereby a temperature detection on the lithium battery charged within the charging groove can be performed.

3. The all-in-one lithium battery charger as recited in claim 1 wherein the first bottom portion of the top casing is flushed with the bottom plate of the charging seat while the higher U-shaped member of the second bottom portion is adjacent to the front side wall of the top casing, whereby a first charging groove is formed in the area between the first charging terminal set and the surface of the second bottom portion, and a second charging groove is formed in the area between the first charging terminal set and the surface of the first bottom portion, and a third charging groove is formed in the area between the first charging terminal set and the inner side of the U-shaped member of the second bottom portion, and a fourth charging groove is formed in the area of the bottom plate and between the second charging terminal set and the side wall of the top casing.

4. The all-in-one lithium battery charger as recited in claim 3 wherein the first charging groove is adapted to receive a Kodak KLIC-7000 lithium battery for performing the charging process.

5. The all-in-one lithium battery charger as recited in claim 3 wherein the second charging groove is adapted to receive a Kodak KLIC-7001/7004/7005 lithium battery for performing the charging process.

6. The all-in-one lithium battery charger as recited in claim 3 wherein the third charging groove is adapted to receive a Kodak KLIC-7003 lithium battery for performing the charging process.

7. The all-in-one lithium battery charger as recited in claim 3 wherein the fourth charging groove is adapted to receive a Kodak KLIC-7006 lithium battery for performing the charging process.

8. The all-in-one lithium battery charger as recited in claim 1 wherein a light-emitting diode is disposed on the circuit board while the top casing includes a round hole from which the top the light-emitting diode projects.

9. The all-in-one lithium battery charger as recited in claim 1 wherein the top casing includes a pivot seat at the rear side thereof for pivotally connecting a swivel cover.
